(19) United States
(12) Patent Application Publication
(10) Pub. No.: US 2006/0039242 A1
(43) Pub. Date: Feb. 23, 2006

(54) All American clock

(76) Inventors: James Ford JR., Clarksdale, MS (US); Barbara Washington-Ford, Decatur, IL (US)

Correspondence Address: Mr. & Mrs. James, 511 Le Flore Street, Clarksdale, MS, 38614, US

(21) Appl. No.: 10/866,947

(22) Filed: Aug. 20, 2004

(51) Int. Cl. G04B 19/00

(52) U.S. Cl. 368/223; 368/228; 368/231; 368/276

(57) ABSTRACT

An abstract of technical disclosure: “The All American Clock” serial #10/866947 1. The backdrop of the clock is the American flag.

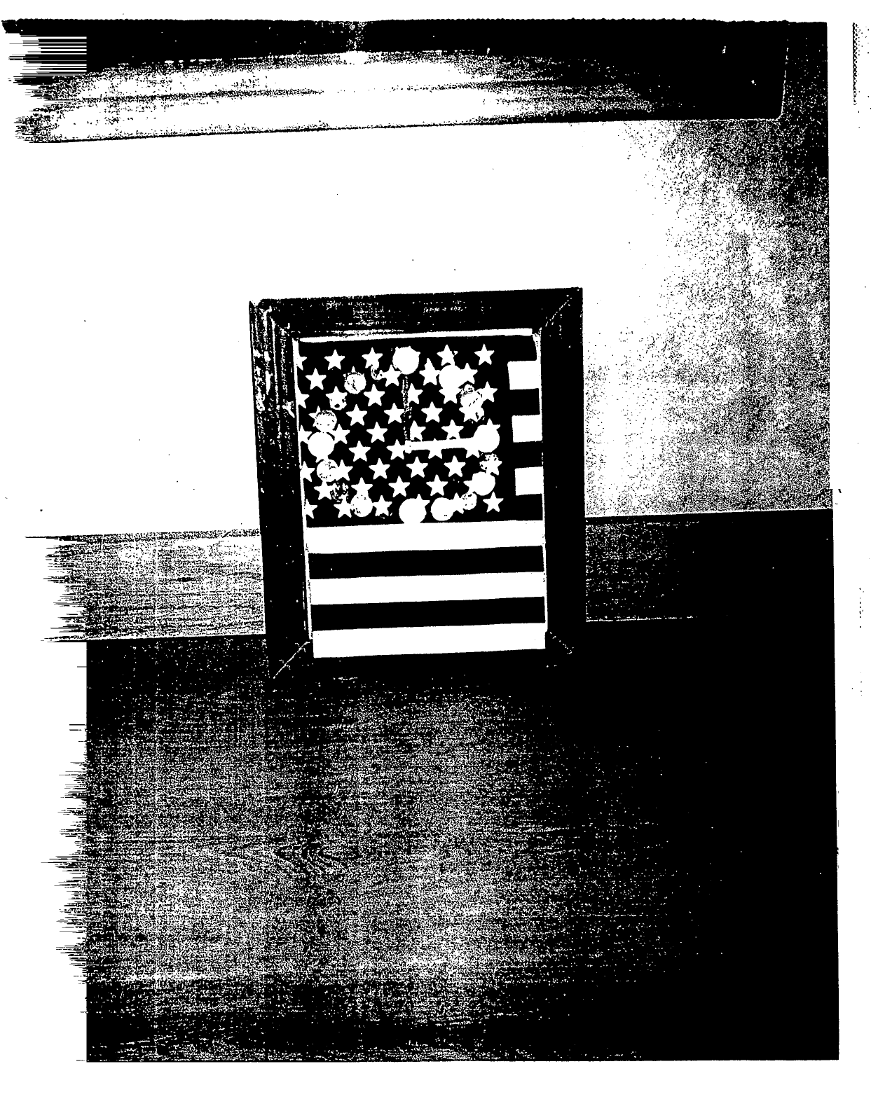

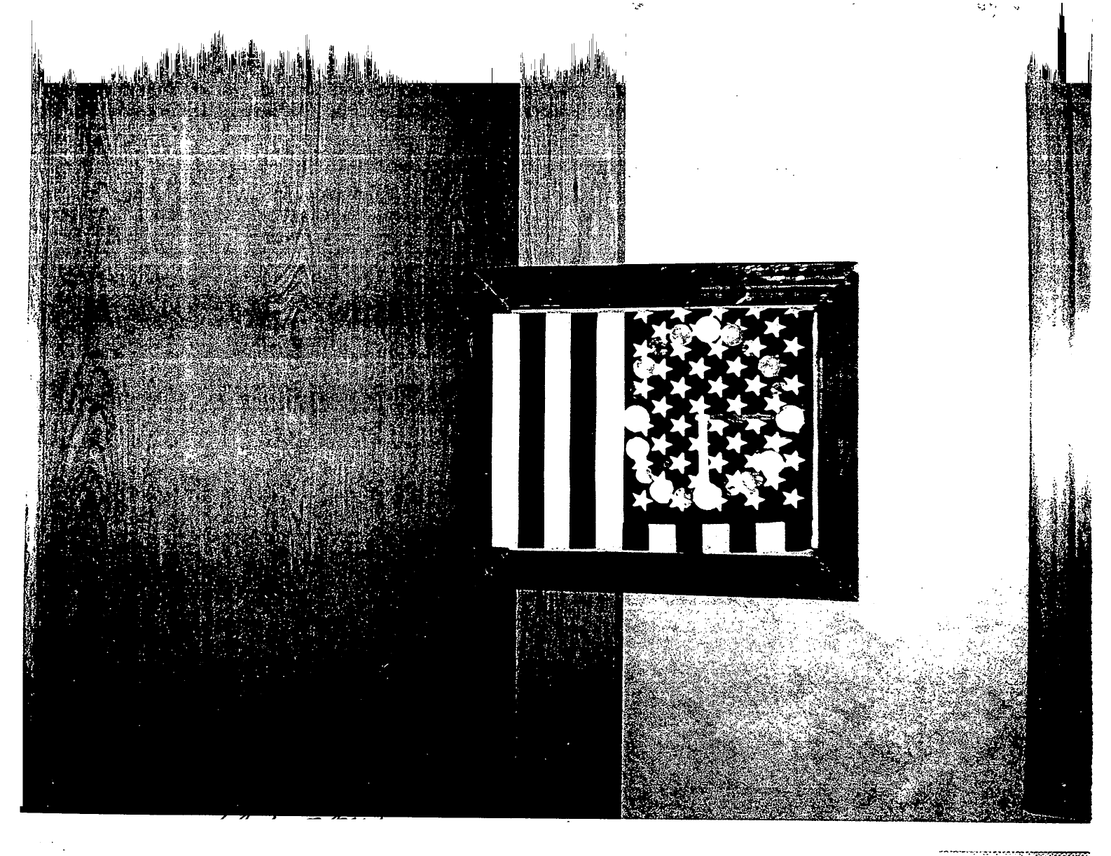

2. In model #3 of the clock, coins representing the hours; and the hands of the clock are positioned on the area of the stars, and will have nickels on the 12 and 6^{th} hour; dimes on the 3^{rd} and 9^{th} hours, and pennies on the other hours.

4. Model #4 of the clock will have quarters on the 12 and 6^{th} hour; nickels on the 3^{rd} and 9^{th} hour, and pennies on the other hours. Coins representing hours; and the hands of the clock will be positioned on the stars/stripes. 5. Can be battery/electricity operated. 6. Can be shaped square, oblong, or round. Can be framed in walnut, or mahogany wood, or plastic. 7. Can be made in various sizes. Can be wall mounted or sit on a surface.

Enclosed information along with four (4) photographs, is the description of my invention: “The All American Clock”.

1. The backdrop of the dock is the American flag. (stars & strips; red, white, and, blue).

2. The face of the clock is positioned on the area of the stars.

3. The clock will have nickels on the 12 (twelve), 3 (three), 6 (six), and 9 (nine) o'clock hours. Pennies will be positioned on the other hours of the clock.

4. The clock will be battery or electricity operated.

5. The clock can be shaped square, oblong, or round; and can be framed in rich walnut or mahogany wood, or plastic.

6. The clock can be made is various sizes.

1. We claim this new invention, ser. No. 10/866,947 “The All American Clock”. “The All American Clock” is a device that is different from any other clock. The backdrop of the clock is the American flag. This new invention will serve as a reminder of who we are; Americans. It represents what we have fought for and will continue to fight for; our right to be a free nation under God with liberty and justice for all. Each coin on the face of the clock; the quarters, dimes, nickels and pennies exude with the legacy of great leadership this nation has been privileged to experience and enjoy.
When placed in federal and state government buildings, as well as numerous American homes, this clock would not only express the loyalty and honor of being an American citizen, but serve as a history lesson of this Country's strength, tenacity, and unity.
